(19) United States
(12) Patent Application Publication
(10) Pub. No.: US 2017/0235255 A1
(43) Pub. Date: Aug. 17, 2017

(54) ELECTRICALLY CONDUCTIVE ROLLER, TRANSFER DEVICE, AND IMAGE FORMING APPARATUS

(71) Applicant: FUJI XEROX CO., LTD., Tokyo (JP)

(72) Inventor: Masato FURUKAWA, Kanagawa (JP)

(73) Assignee: FUJI XEROX CO., LTD., Tokyo (JP)

(21) Appl. No.: 15/231,969

(22) Filed: Aug. 9, 2016

(30) Foreign Application Priority Data
Feb. 17, 2016 (JP) 2016-028218

(51) Int. Cl. G03G 15/16

(52) U.S. Cl. CPC G03G 15/162

(57) ABSTRACT

An electrically conductive roller includes a shaft body, an elastic layer disposed on an external circumferential surface of the shaft body, a tube that covers the elastic layer while being in close contact with the elastic layer and extends beyond two ends of the elastic layer, and projections disposed on internal circumferential surfaces of portions of the tube extending beyond the two ends of the elastic layer.

### CROSS-REFERENCE TO RELATED APPLICATIONS

This application is based on and claims priority under 35 USC 119 from Japanese Patent Application No. 2016-028218 filed Feb. 17, 2016.

### BACKGROUND

(i) Technical Field

The present invention relates to electrically conductive rollers, transfer devices, and image forming apparatuses.

(ii) Related Art

An electrically conductive roller including a shaft body, an elastic layer disposed on the external circumferential surface of the shaft body, and a tube that covers the elastic layer while being in close contact with the elastic layer but not adhering to the external circumferential surface using an adhesive is known. When this electrically conductive roller is pressed against a contact target and rotated around an axis, the tube is distorted in some cases.

### SUMMARY

An electrically conductive roller according to an aspect of the invention includes a shaft body, an elastic layer disposed on an external circumferential surface of the shaft body, a tube that covers the elastic layer while being in close contact with the elastic layer and extends beyond two ends of the elastic layer, and projections disposed on internal circumferential surfaces of portions of the tube extending beyond the two ends of the elastic layer.

### BRIEF DESCRIPTION OF THE DRAWINGS

An exemplary embodiment of the present invention will be described in detail based on the following figures, wherein:

FIG. 1 is a schematic diagram of an image forming apparatus according to an exemplary embodiment viewed from the front:

FIG. 2A is a sectional view of a second roller constituting a transfer device of the image forming apparatus according to the exemplary embodiment, taken along a direction parallel to the axial direction;

FIG. 2B is a side view of the second roller according to the exemplary embodiment viewed from one side in an axial direction;

FIG. 3 is a sectional view of a second roller according to a first comparative form taken along a direction parallel to the axial direction;

FIG. 4A is a front view of the second roller according to the first comparative form in an initial state (factory-shipped state);

FIG. 4B is a front view of the second roller according to the first comparative form in the state where the tube becomes distorted during use;

FIG. 4C is a front view of the second roller according to the first comparative form in the state where the tube that has been distorted during use is recovered from distortion;

FIG. 5 is a front view of a second roller according to the exemplary embodiment in the state where the tube becomes distorted during use;

FIG. 6 is a sectional view of a second roller according to a third comparative form and taken along a direction parallel to the axial direction;

FIG. 7 is a table showing the specifications and evaluation of examples and comparative forms;

FIG. 8A is a side view of a second roller according to a modification example (first modification example) viewed from one side in the axial direction;

FIG. 8B is a side view of a second roller according to a modification example (second modification example) viewed from one side in the axial direction; and

FIG. 8C is a side view of a second roller according to a modification example (third modification example) viewed from one side in the axial direction.

### DETAILED DESCRIPTION

The following describes a mode of embodying the invention (or an exemplary embodiment). Examples are subsequently described.

In the following description, directions denoted by arrows X and −X in the drawings indicate an apparatus width direction and directions denoted by arrows Y and −Y in the drawings indicate an apparatus height direction. Directions perpendicular to both the apparatus width direction and the apparatus height direction (directions denoted by arrows Z and −Z) indicate an apparatus depth direction.

### Exemplary Embodiment

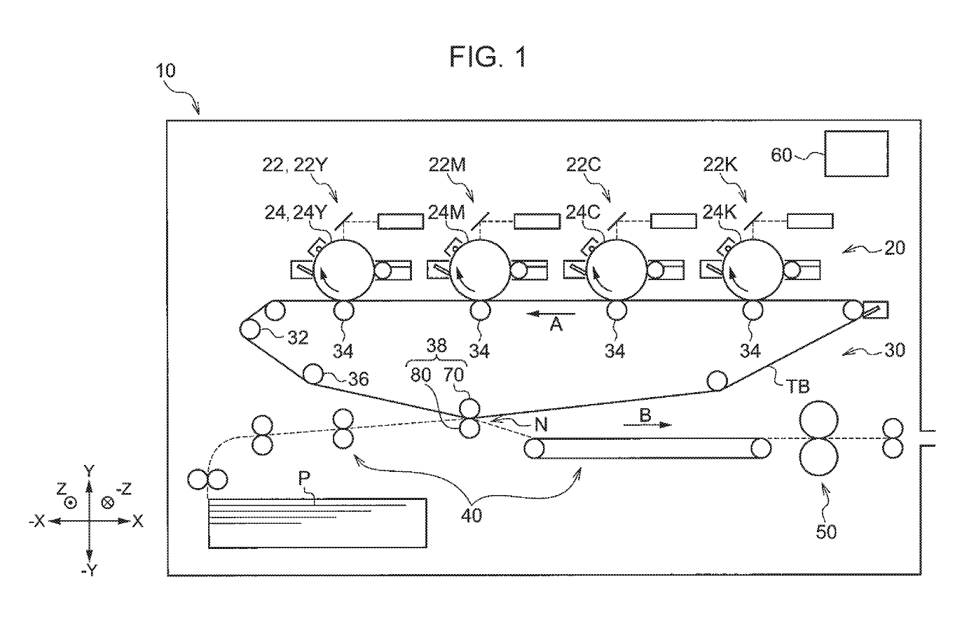

An exemplary embodiment is described below. Firstly, the entire configuration and an image forming operation of an image forming apparatus 10 according to an exemplary embodiment (see FIG. 1) are described, followed by description of the configuration of a characteristic portion (second transfer portion 38) according to the exemplary embodiment, and description of effects of the exemplary embodiment.

### Entire Configuration of Image Forming Apparatus

Referring to FIG. 1, the entire configuration of an image forming apparatus 10 is described below. The image forming apparatus 10 is an electrophotographic apparatus that includes a toner-image forming unit 20, a transfer device 30, a transporting device 40, a fixing device 50, and a controller 60.

### Toner-Image Forming Unit

The toner-image forming unit 20 has a function of forming, on photoconductors 24Y, 24M, 24C, and 24K, toner images (not illustrated) that are to be held by a belt TB by performing steps of electric charging, exposure to light, and development. The belt TB and the photoconductors 24Y, 24M, 24C, and 24K are described below. Here, the toner-image forming unit 20 is an example of a forming unit. The toner image is an example of an image. The toner-image forming unit 20 includes single-color units 22 (22Y, 24M, 24C, and 24K).

### Transfer Device

The transfer device 30 has functions of first-transferring a toner image formed on each photoconductor 24 to the belt TB and second-transferring the toner image held on the belt TB onto a medium P. The transfer device 30 includes the belt TB, a driving roller 32, multiple first rollers 34, a tension roller 36, and a second transfer portion 38. The belt TB is endless and driven by a driving force of the driving roller 32. The belt TB has a function of holding a toner image second-transferred (transferred) to a medium P while rotating in the direction of arrow A. The second transfer portion 38 is described below since the second transfer portion 38 is a characteristic portion of the exemplary embodiment.

### Transporting Device

The transporting device 40 has a function of transporting a medium P in the direction of arrow B.

### Fixing Device

The fixing device 50 has a function of fixing, onto the medium P, toner images that have been second-transferred (transferred) to the medium P by the transfer device 30.

### Controller

The controller 60 has a function of controlling all the components of the image forming apparatus 10 other than itself. The function of the controller 60 is described in the description of the image forming operation, below.

The description given above is about the entire configuration of the image forming apparatus 10 according to the exemplary embodiment.

### Image Forming Operation

Referring now to FIG. 1, an image forming operation is described.

The controller 60 that has received image data from an external device (not illustrated) actuates components of the image forming apparatus 10 other than itself.

Firstly, the single-color units 22 of the toner-image forming unit 20 form toner images of respective colors on the respective photoconductors 24. The toner images formed on the respective photoconductors 24 are first-transferred to the belt TB by the transfer device 30 and held on the belt TB. The toner images are then second-transferred to a medium P transported to the transporting device 40. Subsequently, the medium P to which the toner images have been second-transferred is transported toward the fixing device 50 by the transporting device 40, so that the toner images are fixed to the medium P by the fixing device 50 (an image is formed on the medium P). Thereafter, the medium P on which an image has been formed is ejected to the outside of the image forming apparatus 10 by the transporting device 40. Thus, the image forming operation is complete.

The description given above is about the image forming operation according to each exemplary embodiment.

### Configuration of Characteristic Portion (Second Transfer Portion 38)

Referring now to the drawings, the configuration of the second transfer portion 38 is described. The second transfer portion 38 has a function of second-transferring (transferring) a toner image that has been first-transferred to the belt TB and held on the belt TB, onto a medium P that has been transported to the transporting device 40. As illustrated in FIG. 1, the second transfer portion 38 includes a power supply roller 70 and a second roller 80. The power supply roller 70 and the second roller 80 are electrically conductive rollers.

### Power Supply Roller

The power supply roller 70 is disposed on the inner side of the belt TB. The power supply roller 70 is rendered movable in the apparatus height direction by a moving mechanism (not illustrated). The power supply roller 70 is spaced apart from the belt TB except when performing a transfer operation. When performing a transfer operation, the power supply roller 70 is moved downward in the apparatus height direction by the moving mechanism to come into contact with an internal circumferential surface of the belt TB. The power supply roller 70 is driven to rotate by the belt TB following the rotation of the belt TB. The power supply roller 70 forms a nip P by holding the belt TB between itself and the second roller 80. Here, the power supply roller 70 is an example of a contact portion. The power supply roller 70 is supplied with power from a power source (not illustrated) at the time of second transfer to form, together with the second roller 80, an electric field that causes a toner image to be second-transferred (transferred) to a medium P.

### Second Roller

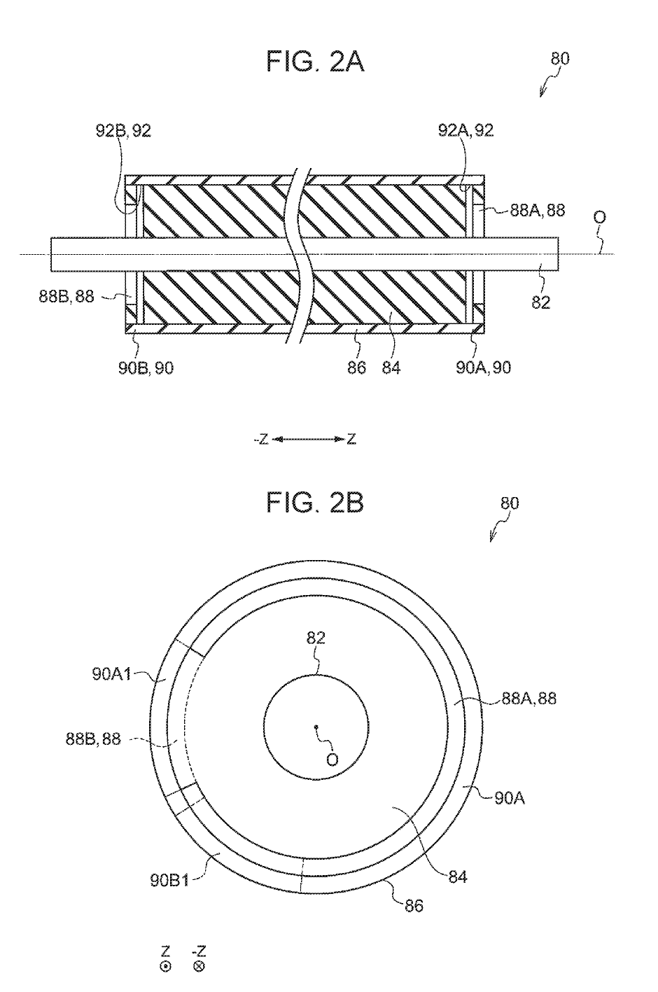

The second roller 80 has a function of second-transferring (transferring) a toner image held on the belt TB to the medium P that has been transported thereto by the transporting device 40 and that passes through the nip N. Here, the second roller 80 is an example of a transfer roller and an electrically conductive roller. The second roller 80 is driven to rotate by the belt TB following the rotation of the belt TB. As illustrated in FIG. 2A and FIG. 2B, the second roller 80 includes a shaft 82, an elastic layer 84, a tube 86, and ribs 88. Here, the shaft 82 is an example of a shaft body.

### Shaft

As illustrated in FIG. 2A, the shaft 82 is a long column. The shaft 82 is rotatably supported by a housing (not illustrated) in the image forming apparatus 10. The shaft 82 is grounded to the housing and constitutes an electric circuit together with the power source and the power supply roller 70. In FIG. 2A (and in drawings other than FIG. 2A), the symbol O denotes an axis.

### Elastic Layer

As illustrated in FIG. 2A and FIG. 2B, the elastic layer 84 is disposed on the external circumferential surface of the shaft 82 while leaving both end portions of the shaft 82 uncovered. The elastic layer 84 is made of, for example, electrically conductive foam. The elastic layer 84 is, for example, a long cylinder, which is symmetrical with respect to the axis O. The internal circumferential surface of the elastic layer 84 is bonded to the external circumferential surface of the shaft 82 using, for example, an adhesive (not illustrated). Thus, the internal circumferential surface of the elastic layer 84 is not displaced with respect to the shaft 82 even when the second roller 80 is driven to rotate by the belt TB. In the second transfer portion 38, the elastic layer 84 holds, between itself and the power supply roller 70, the belt TB and the tube 86 over the range from one end to the other end of the elastic layer 84 in the axial direction (not illustrated).

### Tube

As illustrated in FIG. 2A and FIG. 2B, the tube 86 is, for example, a long cylinder. The axis of the tube 86 is aligned with the axis O. The tube 86 covers the elastic layer 84 while protruding beyond both ends of the elastic layer 84 and being in close contact with the elastic layer 84. Here, the tube 86 is an example of a tube. In this description, “being in close contact” represents that the subject is in direct contact with an object (the elastic layer 84, in the case of the exemplary embodiment). In other words, “being in close contact” represents that the subject is not bonded to an object using an adhesive. In the exemplary embodiment, the tube 86 covers the elastic layer 84, located on the inner side of the tube 86, and compresses the elastic layer 84 in the radial directions of the elastic layer 84. The thickness of the tube 86 is, for example, 0.5 mm, that is, does not exceed 1.0 mm.

In the following description, portions of the tube 86 extending beyond both ends of the elastic layer 84 are referred to as protrusions 90 and the internal circumferential surface of each protrusion 90 is referred to as an internal circumferential surface 92. One of the protrusions 90 located on one side in the axial direction is referred to as a protrusion 90A and the other protrusion 90 located on the other side in the axial direction is referred to as a protrusion 90B. In FIG. 2A and FIG. 2B, for example, one side in the axial direction is referred to as a near side in the apparatus depth direction and the other side in the axial direction is referred to as a far side in the apparatus depth direction. The internal circumferential surface of the protrusion 90A is referred to as an internal circumferential surface 92A and the internal circumferential surface of the protrusion 90B is referred to as an internal circumferential surface 92B.

### Rib

The ribs 88 have a function of restricting the amount of displacement by which the tube 86 is displaced in the axial direction with respect to the elastic layer 84 following the driven rotation of the second roller 80. Thus, the ribs 88 have a function of restricting the amount of distortion when the tube 86 is displaced in the axial direction with respect to the elastic layer 84 as a result of the tube 86 being distorted following the driven rotation of the second roller 80. As illustrated in FIG. 2A, the ribs 88 are disposed on the protrusions 90A and 90B. In the following description, one of the ribs 88 disposed on the protrusion 90A is referred to as a rib 88A and the other rib 88 disposed on the protrusion 90B is referred to as a rib 88B. Unless the rib 88A and the rib 88B need to be particularly distinguished from each other, the rib 88A and the rib 88B are described as the ribs 88.

Each rib 88 is made of, for example, a material the same as the material of the tube 86. The rib 88A and the rib 88B have the same shape. The rib 88A is bonded to the internal circumferential surface 92A of the protrusion 90A with, for example, an adhesive (not illustrated) and the rib 88B is bonded to the internal circumferential surface 92B of the protrusion 90B with, for example, an adhesive (not illustrated).

As illustrated in FIG. 2B, the ribs 88A and 88B have an arcuate shape extending along the internal circumferential surface of the tube 86 when viewed in the axial direction. Each of the ribs 88A and 88B is disposed over the range of, for example, approximately 80% of the full range of the internal circumferential surface of the tube 86 in the circumferential direction, that is, over the range of greater than or equal to approximately 80%. As illustrated in FIG. 2A and FIG. 2B, the rib 88A protrudes toward the shaft 82 from the internal circumferential surface 92A of the protrusion 90A and the rib 88B protrudes toward the shaft 82 from the internal circumferential surface 92B of the protrusion 90B. Here, each rib 88 is an example of a projection. For example, the ribs 88 are spaced apart from the shaft 82. For example, each of the ribs 88A and 88B is a single unit.

Here, as illustrated in FIG. 2B, a portion of the protrusion 90A at which the rib 88A is not disposed when viewed in the axial direction (apparatus depth direction) is referred to as a rib-free portion 90A1. In addition, a portion of the protrusion 90B at which the rib 88B is not disposed when viewed in the axial direction is referred to as a rib-free portion 90B1. In the exemplary embodiment, the rib-free portion 90A1 of the protrusion 90 on one side of the axial direction (protrusion 90A) and the rib-free portion 90B1 of the protrusion 90 on the other side of the axial direction (protrusion 90B) do not overlap with each other when perspectively viewed in the axial direction. In this description, the wording “do not overlap with each other when (perspectively) viewed in the axial direction” represents that the range over which one (for example, the rib-free portion 90A1) lies does not coincide in the axial direction with the range over which the other (for example, the rib-free portion 90B1) lies.

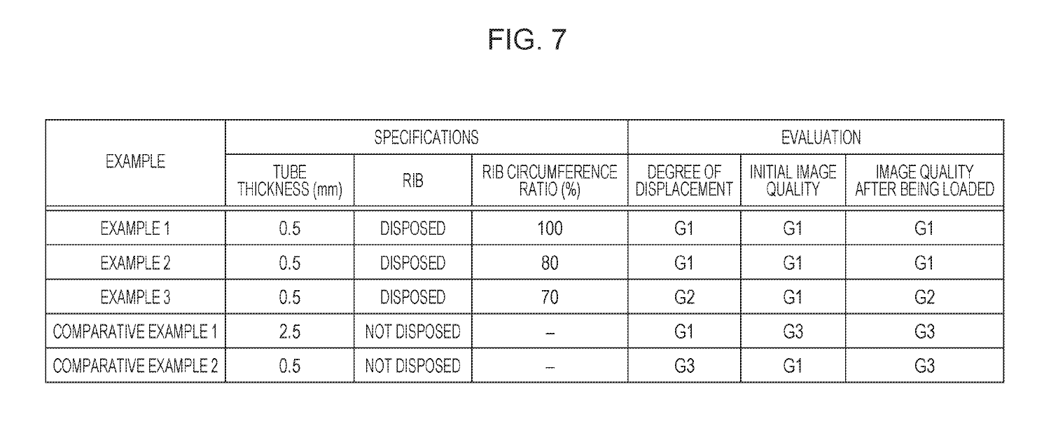

The description given above is the configuration of a characteristic portion of the exemplary embodiment (second transfer portion 38). Here, the second roller 80 according to the exemplary embodiment corresponds to Example 2, described below (see the table in FIG. 7).

### Effects

The following describes effects of an exemplary embodiment (first to fourth effects). Referring now to the drawings, effects of the exemplary embodiment are described while the exemplary embodiment is compared with comparative forms (first to fourth comparative forms), described below. In each comparative form, components the same as those in the exemplary embodiment are denoted with the same symbols or called by the same names although they are not illustrated.

### First Effect

The first effect results from the ribs 88 being disposed on the protrusions 90. Specifically, the first effect results from the ribs 88A and 88B being respectively disposed on the protrusions 90A and 90B. The first effect is described while the exemplary embodiment is compared with a first comparative form.

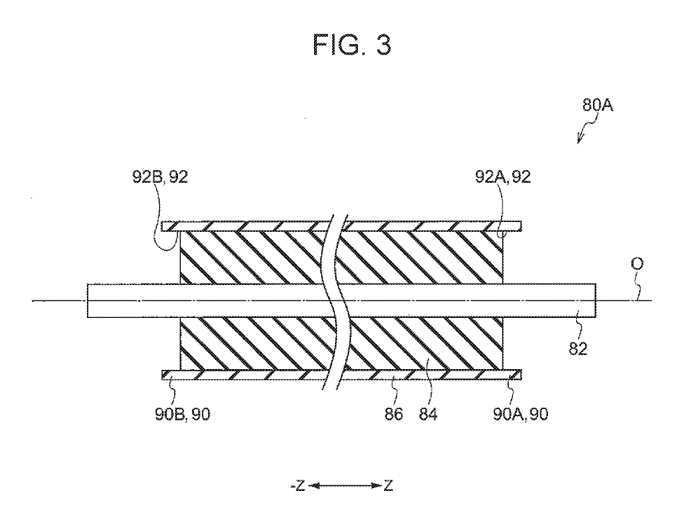

As illustrated in FIG. 3, a second roller 80A of a first comparative form does not include any rib 88. Except for this point, the first comparative form has a configuration similar to the configuration according to the exemplary embodiment. The second roller 80A according to the first comparative form corresponds to Comparative Example 2, described below (see the table in FIG. 7).

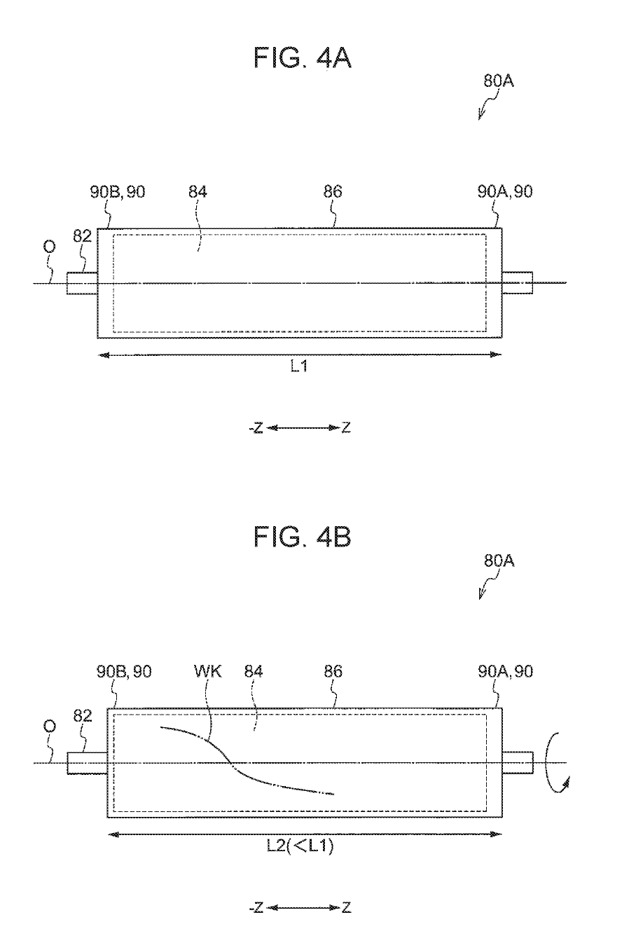

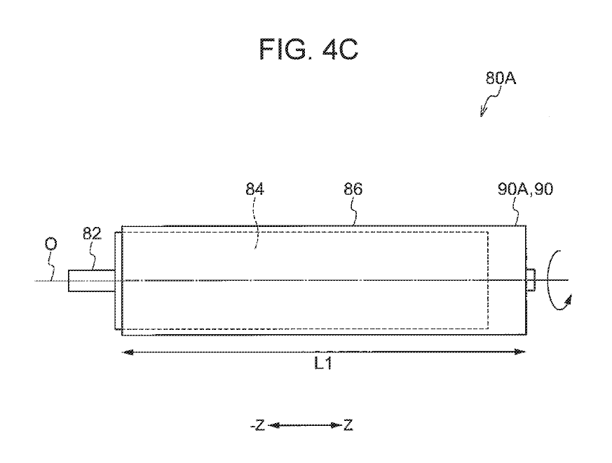

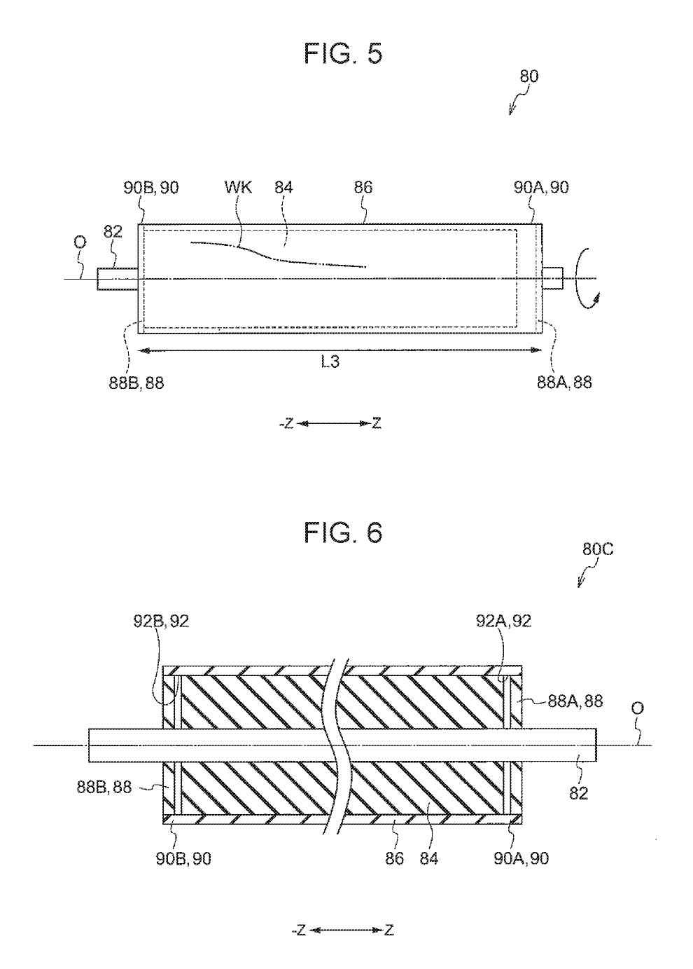

The first comparative form may have the following problem. The problem is described below with reference to FIGS. 4A, 4B, and 4C. The second roller 80A in the initial state (factory-shipped state) has protrusions 90A and 90B on both end portions in the axial direction (apparatus depth direction) (see FIG. 4A). Here, the width of the tube 86 in the initial state is denoted with L1. In some cases, the tube 86 is distorted in the circumferential direction during the use (transfer operation) of the second roller 80A (with the rotation driven by the belt TB). The two-dot chain line WK in FIG. 4B represents a streak (linear ridge portion) formed on the tube 86 as a result of distortion of the tube 86. When the tube 86 is distorted, the width of the tube 86 is changed to a width L2, shorter than the width L1 (L2<L1). Here, FIG. 4B exemplarily illustrates the state where the width of the protrusion 90B is reduced while the width of the protrusion 90A remains unchanged (in the state where the protrusion 90B is displaced toward the near side in the apparatus depth direction). When the tube 86 is repeatedly distorted and recovered from distortion, the tube 86 may be, for example, displaced further toward the near side in the apparatus depth direction, the width of the protrusion 90A may increase, the protrusion 90B may disappear, and part of the elastic layer 84 may become uncovered (see FIG. 4C). This causes transfer errors as a result of part of the elastic layer 84 directly coming into contact with the belt TB.

The second roller 80 according to the exemplary embodiment, on the other hand, includes the ribs 88 on the protrusions 90, as illustrated in FIG. 2A and FIG. 2B. Thus, in the exemplary embodiment, when the tube 86 is distorted in the circumferential direction while being used and reduces its width (to, for example, a width L3 (L3<L1)), the rib 88A or the rib 88B comes into contact with the corresponding end surface of the elastic layer 84.

Thus, in the exemplary embodiment, when the second roller 80 is brought into contact with the belt TB, which is a contact target, and rotated around its axis, the amount of distortion of the tube 86 becomes smaller (the amount of distortion is restricted further) than that of a second roller that does not include ribs 88 at the protrusions 90 of the tube 86.

In addition, in the exemplary embodiment, the elastic layer 84 is less likely to be uncovered even when the tube 86 is displaced in the axial direction since the rib 88A or 88B comes into contact with the end surface of the elastic layer 84 along with the distortion of the tube 86. In other words, in the exemplary embodiment, part of the elastic layer 84 is less likely to directly come into contact with the belt TB even when the tube 86 is displaced in the axial direction.

Thus, the transfer device 30 according to the exemplary embodiment reduces occurrence of transfer errors (causes less transfer errors) compared to a transfer device that includes a second roller that does not include ribs 88 on the protrusions 90 of the tube 86. With the reduction of transfer errors, the image forming apparatus 10 according to the exemplary embodiment reduces occurrence of image forming defects (causes less image forming defects).

As described above, the thickness of the tube 86 according to the exemplary embodiment is 0.5 mm, that is, does not exceed 1.0 mm. Here, the tube 86 having a smaller thickness has better electric characteristics (uniformity of the intensity of the electric field formed in a second transfer in the axial direction) but is more likely to be distorted (see Comparative Examples 1 and 2 in the table in FIG. 7, described below). However, in the exemplary embodiment, the amount of distortion is small regardless of the thickness of the tube 86 being within approximately 1.0 mm (regardless of the tube 86 having such a thickness that the tube 86 is more likely to be distorted). An exemplary embodiment of Example 2 has higher image quality than in the case where the tube 86 has a thickness larger than approximately 1.0 mm (Comparative Example 1) (see the table in FIG. 7, described below). Thus, the exemplary embodiment has an equal or smaller amount of distortion and better electric characteristics than in the case where the tube 86 does not have ribs 88 on the protrusions 90 and has a thickness larger than approximately 1.0 mm, with which the tube 86 is less likely to be distorted (see Examples 1 to 3 and Comparative Example 1 in the table in FIG. 7, described below).

### Second Effect

The second effect results from the range over which each of the rib 88A and the rib 88B is disposed being greater than or equal to approximately 80% of the full range of the internal circumferential surface of the tube 86 in the circumferential direction. The second effect is described while the exemplary embodiment is compared with a second comparative form (not illustrated).

The range over which each of the ribs 88A and 88B of a second roller according to the second comparative form is disposed is approximately 70% of the full range of the internal circumferential surface of the tube 86 in the circumferential direction. The second comparative form has the same configuration as the exemplary embodiment except for this point. The second roller according to the second comparative form corresponds to Example 3, described below (see the table in FIG. 7). Since the second roller according to the second comparative form has the same configuration as the exemplary embodiment except for the above-described point, the second roller is an example of an electrically conductive roller and a transfer roller and has the above-described first effect. In other words, the second comparative form belongs to the technical scope of the present invention.

In the case of the second comparative form, when the tube 86 is displaced in the axial direction while being used and the rib 88A or the rib 88B comes into contact with the end surface of the elastic layer 84, the rib 88A or the rib 88B is pushed by the elastic layer 84, so that the rib 88A or the rib 88B may come off the corresponding internal circumferential surface 92A or 92B of the tube 86.

On the other hand, in the case of the exemplary embodiment, the range over which each of the rib 88A and the rib 88B is disposed is greater than or equal to approximately 80% of the full range of the internal circumferential surface of the tube 86 in the circumferential direction. Thus, in the exemplary embodiment, even when the rib 88A or the rib 88B is pushed by the elastic layer 84, the force that the rib 88A or the rib 88B receives from the elastic layer 84 is dispersed further than in the case of the second comparative form.

Each rib 88 of the second roller 80 according to the exemplary embodiment is less likely to come off the internal circumferential surface 92 than in the case of the second roller in which the range over which each rib 88 is disposed is approximately 70% of the full range of the internal circumferential surface of the tube 86 in circumferential direction. From the above-described mechanism and the evaluation results of Examples and Comparative Examples described below, it is presumed that the ribs 88 are less likely to come off the internal circumferential surfaces 92 in the form in which each of the rib 88A and the rib 88B is disposed over the range greater than or equal to approximately 80% of the full range of the internal circumferential surface of the tube 86 in the circumferential direction than in the form in which each of the rib 88A and the rib 88B is disposed over the range less than approximately 80% of the full range of the internal circumferential surface of the tube 86 in the circumferential direction.

### Third Effect

The third effect results from the ribs 88 being spaced apart from the shaft 82. The third effect is described while the exemplary embodiment is compared with the third comparative form.

As illustrated in FIG. 6, ribs 88A and 88B of a second roller 80C according to a third comparative form are in contact with the external circumferential surface of the shaft 82. Except for this point, the third comparative form has the same configuration as the exemplary embodiment. Since the second roller 80C according to the third comparative form has a configuration the same as the configuration of the exemplary embodiment except for the above-described point, the second roller 80C has the above-described first and second effects. In other words, the second roller 80C is an example of an electrically conductive roller and a transfer roller and the third comparative form belongs to the technical scope of the present invention.

In the case of the third comparative form, the ribs 88A and 88B are in contact with the external circumferential surface of the shaft 82. Thus, in the third comparative form, the electric current that passes across the belt TB and the shaft 82 during a second transfer operation may pass an electric path in the order of the belt TB, the tube 86, the rib 88A (or the rib 88B), and the shaft 82 without passing the elastic layer 84 (particularly in a high-temperature high-humidity environment). In the third comparative form, the area (or contact resistance) over which the rib 88A (or the rib 88B) and the shaft 82 come into contact with each other changes due to the displacement of the tube 86 in the axial direction. Thus, in the third comparative form, the electric characteristics of the second roller 80C may become unstable.

In contrast, in the exemplary embodiment, the ribs 88 are spaced apart from the shaft 82. Thus, in the exemplary embodiment, the electric current that passes across the belt TB and the shaft 82 during a second transfer operation is less likely to pass (or never passes) an electric path in the order of the belt TB, the tube 86, the rib 88A (or the rib 88B), and the shaft 82 without passing the elastic layer 84.

Thus, the exemplary embodiment has more stable electric characteristics than in the case where the ribs 88 are in contact with the external circumferential surface of the shaft 82.

### Fourth Effect

The fourth effect results from the rib-free portion 90A1 of the protrusion 90A not overlapping the rib-free portion 90B1 of the protrusion 90B when perspectively viewed in the axial direction. The fourth effect is described while the exemplary embodiment is compared with a fourth comparative form (not illustrated).

A second roller according to the fourth comparative form has a configuration in which a rib-free portion 90A1 of the protrusion 90A and a rib-free portion 90B1 of the protrusion 90B overlap with each other when perspectively viewed in the axial direction. Specifically, in the fourth comparative form, the rib-free portion 90A1 and the rib-free portion 90B1 of the second roller in the axial direction are located at the same position in the circumferential direction. Except for this point, the fourth comparative form has the same configuration as the exemplary embodiment. The second roller according to the fourth comparative form is an example of an electrically conductive roller and a transfer roller. Since the second roller has the same configuration as the exemplary embodiment except for the above-described point, the second roller has the above-described first, second, and third effects. In other words, the fourth comparative form belongs to the technical scope of the present invention.

In the fourth comparative form, a portion of the tube 86 extending in the axial direction, including the rib-free portion 90A1 (and the rib-free portion 90B1) of the tube 86 in the circumferential direction, is not reinforced with the ribs 88 in contrast to the corresponding portion of the tube 86 extending in the axial direction and including at least one portion of the tube 86 on which either one or both the ribs 88 are disposed in the circumferential direction. In other words, the second roller according to the fourth comparative form includes, in the circumferential direction, a portion that is reinforced with the ribs 88 and a portion that is not reinforced with the ribs 88.

This configuration of the fourth comparative form may cause banding errors in a second transfer (image unevenness that results from cyclic rotation of the second roller) that occur at a rotation cycle of the second roller. In the second roller according to the fourth comparative form, the difference in number of ribs 88 between a portion not reinforced with the ribs 88 and a portion reinforced with the ribs 88 is two.

In the second roller 80 according to the exemplary embodiment, in contrast, the rib-free portion 90A1 and the rib-free portion 90B1 do not overlap with each other when perspectively viewed in the axial direction. Thus, at least one of the rib 88A and the rib 88B is disposed on the tube 86 of the second roller 80 according to the exemplary embodiment when perspectively viewed in the axial direction.

In the second roller 80 according to the exemplary embodiment, the difference in number of ribs 88 disposed on the tube 86 in the circumferential direction between a portion having most ribs and a portion having least ribs is one. In other words, compared to the second roller according to the fourth comparative form, the second roller 80 according to the exemplary embodiment has a smaller difference in strength in the circumferential direction due to the reinforcement of the ribs 88.

Thus, the second roller 80 according to the exemplary embodiment is less likely to cause banding errors in a second transfer than in the second roller in which the rib-free portion 90A1 of the protrusion 90A and the rib-free portion 90B1 of the protrusion 90B overlap with each other when perspectively viewed in the axial direction.

The description given above is the effects of the exemplary embodiment.

### Example

Referring now to the table in FIG. 7, examples are described. In the description of examples and comparative examples, components the same as those used in the exemplary embodiment or the comparative forms are denoted with the same reference symbols.

Second rollers of examples (Examples 1 to 3) and comparative examples (Comparative Examples 1 and 2) having the specifications in the table of FIG. 7 were evaluated in terms of the degree of displacement (amount of displacement) of the tube 86 and the image quality before and after being loaded.

### Specifications of Examples and Comparative Examples

The specifications of Examples 1 to 3 are shown in the table of FIG. 7. Here, the thickness (mm) of the tube represents the thickness of the tube 86. The rib represents whether the ribs 88 having an arcuate shape are disposed or not disposed. The rib circumference ratio represents the range over which the ribs 88 are disposed with respect to the full range of the internal circumferential surface of the tube 86 in the circumferential direction. The height of the ribs 88 in Example 1 and 3 is the same as that of the ribs 88 according to the exemplary embodiment (see FIG. 2A and FIG. 2B). Comparative Example 1 has the same configuration as the above-described comparative form (that is, Comparative Example 2 (see FIG. 3)) except for the thickness of the tube 86.

### Evaluation Method

### Evaluation of Degree of Displacement

In the evaluation of the degree of displacement, a transfer roller of a second transfer portion of Color 1000 Press (manufactured by Fuji Xerox Co., Ltd.) was replaced with the second roller of each of Examples and Comparative Examples and the second roller was attached to the second transfer portion. A halftone image of 100% cyan was printed on 10,000 media P having an A4 size and then the amount of displacement in the axial direction of the tube 86 was measured and evaluated in three grades. Here, the three grades are G1, G2, and G3 in descending order of the evaluation. The second rollers were graded G1 when the tube 86 was displaced only within a predetermined range (for example, +/−0.3 mm in the axial direction) at the measurement. The second rollers were graded G2 when the tube 86 was displaced beyond the predetermined range at the measurement but the protrusions 90A and 90B were not completely disappeared. The second rollers were graded G3 when either the protrusion 90A or the protrusion 90B disappeared or the tube 86 was broken at the measurement. In the evaluation of the degree of displacement, the grades G1 and G2 were defined as acceptable and the grade G3 was defined as unacceptable.

### Evaluation of Image Quality

In the evaluation of image quality, a transfer roller of a second transfer portion of Color 1000 Press (manufactured by Fuji Xerox Co., Ltd.) was replaced with the second roller of each of Examples and Comparative Examples and the second roller was attached to the second transfer portion. A halftone image of 100% cyan was printed on 10,000 media P having an A4 size. In each evaluation, the density unevenness of a first medium P on which the image was formed first and a last medium P on which the image was formed 10,000th was measured with a visual inspection and evaluated in three grades. Here, the three grades are G1, G2, and G3 in descending order of the evaluation. The second rollers were graded G1 when the image was judged to have no image unevenness. The second rollers were graded G2 when the image was judged to have partial image unevenness but the image quality was at an acceptable level. The second rollers were graded G3 when the image was judged to have image unevenness throughout the image and the image quality was at an unacceptable level. In the evaluation of the image quality, the grades G1 and G2 were defined as acceptable and the grade G3 was defined as unacceptable. In the evaluation of the image quality, the image quality of the first medium P was defined as an initial image quality and the image quality of the last medium P was defined as an image quality after being loaded.

### Evaluation Results

As illustrated in the table in FIG. 7, in the evaluations of the degree of displacement and the image quality (initial image quality and image quality after being loaded), Examples 1 to 3 were judged acceptable (graded G1 or G2). In contrast, in any of the evaluations of the degree of displacement and the image quality (initial image quality and image quality after being loaded), Comparative Examples 1 and 2 were judged unacceptable (graded G3). Consideration

The above-described evaluation results are considered below.

According to the above-described evaluation results, Examples 1 and 3 corresponding to the exemplary embodiment (Example 2) and a modification example of the exemplary embodiment conceivably have the effects (first to fourth effects) according to the above-described exemplary embodiment. When viewed from another angle, Comparative Example 2 conceivably fails to have the above-described first effect without there being the ribs 88. As described in the description of the first effect, Comparative Example 1 is conceivably judged acceptable or graded G1 in the degree of displacement since the thickness of the tube 86 is greater than 1.0 mm (that is, 2.5 mm), which is the thickness less likely to cause wrinkles WK. However, since the thickness of the tube 86 is greater than 1.0 mm (that is, 2.5 mm), Comparative Example 1 is disadvantageous in electric characteristics, so that Comparative Example 1 was judged unacceptable (graded G3) in the evaluations of the image quality (initial image quality and image quality after being loaded).

In the above-described evaluation results, in the case where the rib circumference ratio is greater than or equal to approximately 80%, that is, in the cases of Examples 1 and 2, the evaluations of the degree of displacement and the image quality (image quality after being loaded) are better than in the case where the rib circumference ratio is approximately 70%, which is an example of the ratio below 80%. These results probably show that Examples 1 and 2 have the above-described second effect.

The description given above is about Examples.

Thus far, the present invention has been described using a specific exemplary embodiment as an example. However, the present invention is not limited to the above-described exemplary embodiment. The technical scope of the present invention includes, for example, the following forms.

In the exemplary embodiment, the second roller 80 has been described as a transfer roller. However, the second roller 80 may be an electrically conductive roller instead of a transfer roller as long as the second roller 80 is usable so as to rotate or be rotated around the axis while being in contact with a contact target. For example, an electrically conductive roller having a configuration the same as the configuration of the second roller 80 may be used as a charging roller that is to be in contact with a photoconductor. Here, banding errors of a charging roller in this case represent charging unevenness that occurs in a rotation cycle.

In the exemplary embodiment, the ribs 88 are described as being made of the same material as the material of the tube 86. However, the ribs 88 may be made of a material different from the material of the tube 86 as long as the ribs 88 have a function of restricting the amount of distortion of the tube 86 or the amount of displacement of the tube 86 in the axial direction. For example, the ribs 88 may be made of an insulating material.

In the exemplary embodiment, the ribs 88A and 88B are described as having an arcuate shape extending along the internal circumferential surface of the tube 86 when viewed in the axial direction. However, the ribs 88 may have a shape other than an arcuate shape as long as the ribs 88 have a function of restricting the amount of distortion of the tube 86 or the amount of displacement of the tube 86 in the axial direction. For example, the ribs 88 may have a triangular or rectangular shape when viewed in the axial direction. In addition, the rib 88A and the rib 88B may have different shapes.

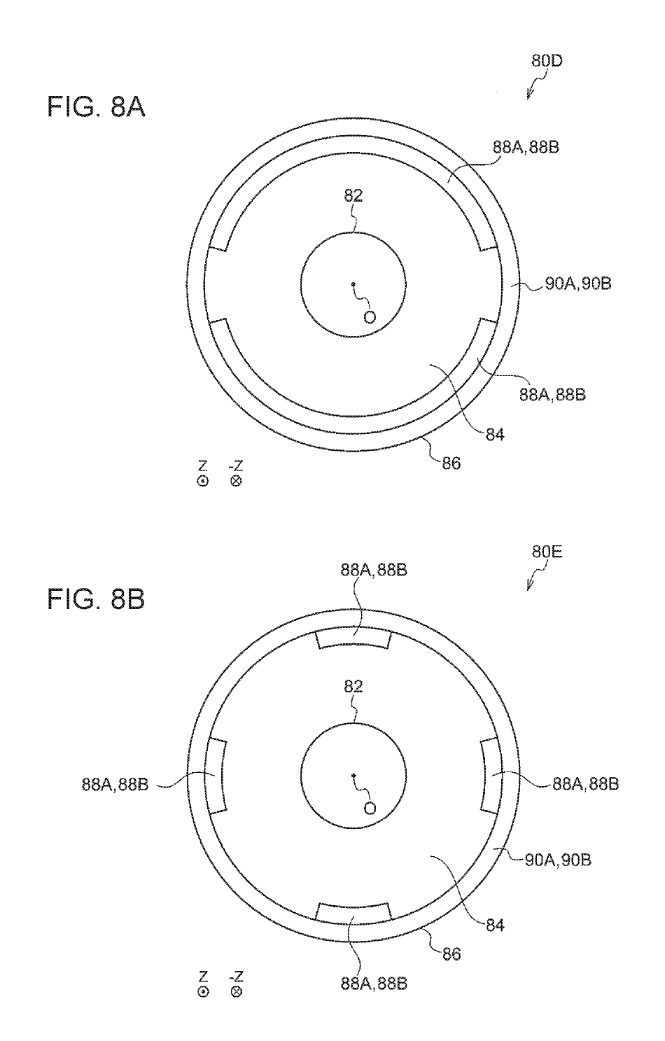

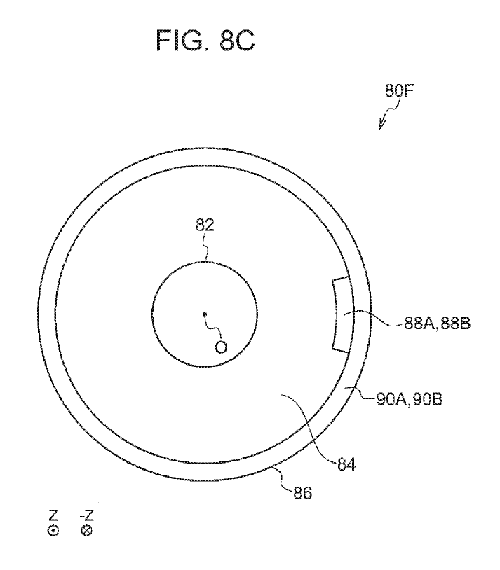

In the exemplary embodiment, each of the rib 88A and the rib 88B is described as being a single unit (see FIG. 2B). However, each of the rib 88A and the rib 88B does not have to be a single unit as long as each of the rib 88A and the rib 88B has a function of restricting the amount of distortion of the tube 86 or the amount of displacement of the tube 86 in the axial direction. For example, each of the rib 88A and the rib 88B may be divided into multiple pieces, such as two pieces as in a second roller 80D illustrated in FIG. 8A or four pieces as in a second roller 80E illustrated in FIG. 8B. The second rollers 80D and 80E are examples of electrically conductive rollers and transfer rollers.

In the exemplary embodiment and each example, the range in the circumferential direction over which the ribs 88 are disposed has been described as being greater than or equal to approximately 70% of the full range of the internal circumferential surface of the tube 86 in the circumferential direction. However, the range in the circumferential direction over which the ribs 88 are disposed may be smaller than approximately 70% as long as the ribs 88 have a function of restricting the amount of distortion of the tube 86 or the amount of displacement of the tube 86 in the axial direction. For example, as in a second roller 80F illustrated in FIG. 8C, the range in the circumferential direction over which the ribs 88 (rib 88A and rib 88B) are disposed may be, for example, 10% of the full range of the internal circumferential surface of the tube 86 in the circumferential direction. Here, the second roller 80F is an example of an electrically conductive roller and a transfer roller.

In the exemplary embodiment, the second roller 80 has been described as being driven to rotate by the belt TB with the rotation of the belt T. However, the rotation of the second roller 80 is not limited to the rotation driven by the belt TB as long as the second roller 80 has a function of second-transferring (transferring) a toner image held on the belt TB onto a medium P that has been transported thereto by the transporting device 40 and that passes through the nip N. For example, the second roller 80 may be driven to rotate by a separately disposed driving unit (not illustrated). Also in this form, the ribs 88 have a function of restricting the amount of distortion, as in the case of the exemplary embodiment, when the tube 86 is distorted in the axial direction with respect to the elastic layer 84 along with the transfer operation (for example, due to the difference in peripheral speed between the second roller 80 and the belt TB).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrically conductive roller, comprising:
a shaft body;
an elastic layer disposed on an external circumferential surface of the shaft body;
a tube that covers the elastic layer while being in close contact with the elastic layer and extends beyond two ends of the elastic layer; and
projections disposed on internal circumferential surfaces of portions of the tube extending beyond the two ends of the elastic layer.

2. The electrically conductive roller according to claim 1, wherein the tube has a thickness of approximately 1.0 mm or smaller.

3. The electrically conductive roller according to claim 1, wherein each of the projections is disposed over a range greater than or equal to approximately 80% of a full range of a corresponding one of the internal circumferential surfaces in a circumferential direction.

4. The electrically conductive roller according to claim 2, wherein each of the projections is disposed over a range greater than or equal to approximately 80% of a full range of a corresponding one of the internal circumferential surfaces in a circumferential direction.

5. The electrically conductive roller according to claim 3,
wherein each of the projections has an arcuate shape extending along the corresponding internal circumferential surface when viewed in an axial direction of the shaft body, and
wherein, when perspectively viewed in the axial direction, a portion of one of the extending portions at which the corresponding projection is not disposed when viewed from a first side in the axial direction does not overlap with a portion of the other extending portion at which the other projection is not disposed when viewed from a second side in the axial direction.

6. The electrically conductive roller according to claim 4,
wherein each of the projections has an arcuate shape extending along the corresponding internal circumferential surface when viewed in an axial direction of the shaft body, and
wherein, when perspectively viewed in the axial direction, a portion of one of the extending portions at which the corresponding projection is not disposed when viewed from a first side in the axial direction does not overlap with a portion of the other extending portion at which the other projection is not disposed when viewed from a second side in the axial direction.

7. A transfer device, comprising:
a belt that is endless and that holds, while rotating, an image that is to be transferred to a medium;
a contact portion that comes into contact with an internal circumferential surface of the belt; and
the electrically conductive roller according to claim 1 that forms a nip by holding the belt between the electrically conductive roller and the contact portion, the electrically conductive roller serving as a transfer roller that transfers the image to the medium that passes through the nip.

8. An image forming apparatus, comprising:
the transfer device according to claim 7;
an image forming portion that forms an image held on the belt; and
a fixing device that fixes, to the medium, the image that has been transferred to the medium by the transfer device.
